(19) United States
(12) Patent Application Publication
(10) Pub. No.: US 2015/0244440 A1
(43) Pub. Date: Aug. 27, 2015

(54) SCALABLE ESTIMATION RING

(71) Applicant: Telefonaktiebolaget L M Ericsson (publ), Stockholm (SE)

(72) Inventors: Marthinus Willem Da Silveira, Ottawa (CA); Neil McGowan, Stittsville (CA); Slim Ben Ghalba, Kanata (CA)

(73) Assignee: Telefonaktiebolaget L M Ericsson (publ), Stockholm (SE)

(21) Appl. No.: 14/191,005

(22) Filed: Feb. 26, 2014

(51) Int. Cl. H04B 7/06; H04L 25/02

(52) U.S. Cl. CPC H04B 7/06; H04L 25/0204; H04L 25/0212; H04W 88/08

(57) ABSTRACT

Systems and methods are disclosed for estimating impulse responses of multiple channels, e.g., multiple antenna sub-array paths of a base station, in a distributed manner. In one embodiment, a method of operation of a Scalable Estimation Ring (SER) processing component in a SER that operates to estimate impulse responses of corresponding channels is provided. In one embodiment, the method includes, during a first iteration of the SER, receiving a feedback signal for the SER processing component and computing an initial estimate of an impulse response of a corresponding channel based on the feedback signal, removing a contribution of the corresponding channel from the feedback signal based on the initial estimate of the impulse response of the corresponding channel to thereby provide a feedback signal for a next SER processing component in the SER, and outputting the feedback signal for the next SER processing component in the SER.

### FIELD OF THE DISCLOSURE

The present disclosure relates to antenna calibration and, in particular, to antenna calibration in a base station of a wireless, or cellular, network.

### BACKGROUND

Base stations having antenna arrays have been widely used in cellular networks for directional signal transmission and reception with an increased gain compared to an omni-directional antenna. The increased gain translates into a higher cell density and data throughput. An antenna array needs to be calibrated across its sub-array paths to remove any linear phase and/or amplitude distortions (hereafter simply referred to as phase distortion) in these paths. If the transmission beam pattern is out of phase or otherwise phase-distorted, the signal transmitted by the base station at normal transmission power may not be correctly received and decoded by a wireless device, e.g., a user terminal. To compensate for the phase distortions, the base station may transmit data at a higher power level; however, increasing the transmission power acts as a load to the system, causing a reduction to the power that can be allocated to other wireless devices. In addition, the signal transmitted at higher power may interfere with other terminals, causing a reduction in signal quality.

Calibration of the antenna array is typically performed by careful coordination of radio signals transmitted by the sub-arrays of an antenna array. Coordination of the radio signals transmitted by the sub-arrays requires signal correction or compensation, which in turn requires estimation of impulse responses of the sub-array paths (i.e., transmit or receive paths). Estimation of the impulse responses of the sub-array paths is normally done using centralized processing in a radio unit where the correction and compensation is done. In this regard, commonly owned and assigned U.S. patent application Ser. No. 13/894,826, entitled METHOD AND APPARATUS FOR ANTENNA ARRAY CALIBRATION USING TRAFFIC SIGNALS, which was filed May 13, 2013, discloses systems and methods for calibrating an antenna array using a centralized architecture.

Base stations for advanced 4^{th} Generation (4G) and 5^{th} Generation (5G) wireless, or cellular, networks require many radio units and many antennas. Further, it is important for base stations in these 4G and 5G wireless networks to be scalable and modular in order for the base stations to be cost effective and manageable. One issue with a centralized approach for estimating the impulse responses of the sub-array paths in such a base station is that a complexity of the centralized approach increases as the number of radio units (or sub-array paths) increases. This increases the cost and complexity of the base station.

As such, there is a need for systems and methods for estimating impulse responses of sub-arrays paths in a base station having an antenna array that enhance scalability and modularity of the base station without increasing the complexity of the base station.

### SUMMARY

Systems and methods are disclosed for estimating impulse responses of multiple channels, e.g., multiple sub-array paths of a base station having an antenna array including multiple antenna sub-arrays, in a distributed manner. By estimating the impulse responses of the channels in a distributed manner, the use of a centralized impulse response estimation architecture is avoided, which in turn reduces complexity and increases modularity.

In one embodiment, a method of operation of a Scalable Estimation Ring (SER) processing component in a SER including multiple SER processing components that operate to estimate impulse responses of corresponding channels is provided. In one embodiment, the method of operation of the SER processing component includes, during a first iteration of the SER, receiving a feedback signal for the SER processing component and computing an initial estimate of an impulse response of a corresponding channel based on the feedback signal for the SER processing component. The method further includes removing a contribution of the corresponding channel from the feedback signal for the SER processing component based on the initial estimate of the impulse response of the corresponding channel to thereby provide a feedback signal for a next SER processing component in the SER. The method also includes outputting the feedback signal for the next SER processing component in the SER. By removing the contribution of the corresponding channel from the feedback signal for the SER processing component to provide the feedback signal for the next SER processing component, the feedback signal for the next SER processing component is less noisy, which in turn results in better impulse response estimation.

In one embodiment, the method of operation of the SER processing component further includes, during a second iteration of the SER, receiving a new feedback signal output by a preceding SER processing component in the SER and adding the contribution of the corresponding channel previously removed from the feedback signal for the SER processing component based on the initial estimate of the impulse response of the corresponding channel into the new feedback signal to thereby provide a modified new feedback signal. The method of operation of the SER processing component during the second iteration further includes computing a new estimate of the impulse response of the corresponding channel based on the modified new feedback signal and removing a contribution of the corresponding channel from the modified new feedback signal based on the new estimate of the impulse response of the corresponding channel to thereby provide a new feedback signal for the next SER processing component in the SER. The method also includes, for the second iteration of the SER, outputting the new feedback signal for the next SER processing component in the SER.

In one embodiment, the SER processing component is a first SER processing component in the SER, and receiving the feedback signal for the SER processing component includes receiving a combined feedback signal, where the combined feedback signal is a summation of output signals of the channels in response to corresponding input signals.

In one embodiment, the channels are transmit paths of a base station of a cellular communications network, where the base station has an antenna array that includes multiple antenna sub-arrays. Each transmit path is connected to a corresponding antenna sub-array. In one embodiment, each transmit path includes a transmit chain, a feeder having a first end connected to an output of the transmit chain and a second end, and a coupler configured to connect the second end of the feeder to a corresponding sub-array. Further, in one embodiment, the transmit chains of the transmit paths are implemented in a single radio unit. In another embodiment, the transmit paths of at least two of the transmit paths are implemented in different radio units. In another embodiment, the transmit chains of the transmit paths are implemented in different radio units.

In one embodiment, the channels are receive paths of a base station of a cellular communications network, where the base station has an antenna array including multiple antenna sub-arrays. Each receive path is connected to a corresponding one of the plurality of antenna sub-arrays.

In one embodiment, for each SER processing component in the SER, removing the contribution of the corresponding channel from the feedback signal for the next SER processing component based on the initial estimate includes subtracting a convolution of a corresponding input signal and the initial estimate of the impulse response of the corresponding channel from the feedback signal for the next SER processing component. In one embodiment, for each SER processing component in the SER, adding the contribution of the corresponding channel previously removed from the combined feedback signal based on the initial estimate into the new feedback signal includes adding the convolution of the corresponding input signal and the initial estimate of the impulse response of the corresponding channel to the new feedback signal to thereby provide the modified new feedback signal, and removing the contribution of the corresponding channel from the modified new feedback signal based on the new estimate for the SER processing component includes subtracting a convolution of the corresponding input signal and the new estimate of the impulse response of the corresponding channel from the modified new feedback signal.

In one embodiment, outputting the feedback signal includes outputting the feedback signal to a baseband unit for distribution to the next SER processing component in the SER. In another embodiment, outputting the feedback signal includes outputting the feedback signal directly to the next SER processing component in the SER.

In one embodiment, a SER processing component that operates according to any of the embodiments above is provided.

In one embodiment, a method of operation of a SER including multiple SER processing components to estimate impulse responses of corresponding channels is provided. In one embodiment, the method includes performing an initial iteration of the SER. Performing the initial iteration of the SER includes, for each SER processing component in the SER: receiving a feedback signal for the SER processing component, computing an initial estimate of an impulse response of a corresponding channel based on the feedback signal for the SER processing component, removing a contribution of the corresponding channel from the feedback signal for the SER processing component based on the initial estimate of the impulse response of the corresponding channel to thereby provide a feedback signal for a next SER processing component in the SER, and outputting the feedback signal for the next SER processing component in the SER.

In one embodiment, for a first SER processing component in the SER, the feedback signal for the initial iteration is a combined feedback signal that is a summation of output signals of the channels in response to corresponding input signals. Further, in one embodiment, for each additional SER processing component in the SER, the feedback signal for the initial iteration is the feedback signal output by a preceding SER processing component in the SER for the initial iteration.

In one embodiment, the method of operation of the SER further includes performing a second iteration of the SER. Performing the second iteration of the SER includes, for each SER processing component in the SER, receiving a new feedback signal output by a preceding SER processing component in the SER, adding the contribution of the corresponding channel removed in the initial iteration of the SER into the new feedback signal to thereby provide a modified new feedback signal, computing a new estimate of the impulse response of the corresponding channel based on the modified new feedback signal, removing a contribution of the corresponding channel from the modified new feedback signal based on the new estimate of the impulse response of the corresponding channel to thereby provide a new feedback signal for the next SER processing component in the SER, and outputting the new feedback signal for the next SER processing component in the SER.

In one embodiment, a SER that operates according to any of the embodiments above is provided.

In one embodiment, a base station for a wireless network that performs calibration of an antenna array to remove distortion incurred by multiple transmit paths in the base station is provided. The antenna array of the base station includes multiple sub-arrays each connected to a corresponding one of the transmit paths. In one embodiment, the base station includes a feedback receiver and a SER. The feedback receiver is configured to receive a combined radio frequency feedback signal and output a combined feedback signal, the combined radio frequency feedback signal being a summation of output signals of the transmit paths in response to corresponding input signals. The SER is configured to estimate impulse responses of the transmit paths based on the combined feedback signal in a distributed manner. The SER includes multiple SER processing components each operating to estimate the impulse response of a corresponding one of the transmit paths.

In one embodiment, each transmit path includes a transmit chain, a feeder having a first end connected to an output of the transmit chain and a second end, and a coupler configured to connect the second end of the feeder to a corresponding sub-array. Further, in one embodiment, the transmit chains of the transmit paths are implemented in a single radio unit. In another embodiment, the transmit chains of the transmit paths are implemented in different radio units. In another embodiment, the transmit chains of at least two of the transmit paths are implemented in different radio units.

In one embodiment, in order to estimate the impulse responses of the transmit paths, for an initial iteration of the SER, each SER processing component in the SER is configured to receive a feedback signal for the SER processing component, compute an initial estimate of the impulse response of a corresponding transmit path based on the feedback signal for the SER processing component, remove a contribution of the corresponding transmit path from the feedback signal for the SER processing component based on the initial estimate of the impulse response of the corresponding transmit path to thereby provide a feedback signal for a next SER processing component in the SER, and output the feedback signal for the next SER processing component in the SER.

In one embodiment, for a first SER processing component in the SER, the feedback signal for the initial iteration is the combined feedback signal from the feedback receiver. Further, in one embodiment, for each additional SER processing component in the SER, the feedback signal for the initial iteration is the feedback signal output by a preceding SER processing component in the SER for the initial iteration.

In one embodiment, in order to estimate the impulse responses of the transmit paths, for a second iteration of the SER, each SER processing component in the SER is configured to receive a new feedback signal output by a preceding SER processing component in the SER, add the contribution of the corresponding transmit path removed in the initial iteration of the SER into the new feedback signal to thereby provide a modified new feedback signal, compute a new estimate of the impulse response of the corresponding transmit path based on the modified new feedback signal, remove a contribution of the corresponding transmit path from the modified new feedback signal based on the new estimate of the impulse response of the corresponding transmit path to thereby provide a new feedback signal for the next SER processing component in the SER, and output the new feedback signal for the next SER processing component in the SER.

Those skilled in the art will appreciate the scope of the present disclosure and realize additional aspects thereof after reading the following detailed description of the embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a centralized architecture for estimating impulse responses of channels formed by multiple modules;

FIG. 2 illustrates a system implementing a distributed architecture for estimating impulse responses of channels formed by multiple modules according to one embodiment of the present disclosure;

FIGS. 3A and 3B illustrate the operation of the system of FIG. 2, and in particular the Scalable Estimation Ring (SER) of the system of FIG. 2, to estimate the impulse responses of the channels according to one embodiment of the present disclosure;

FIG. 4 is a flow chart that illustrates the operation of the m-th SER coordinated processing component in the SER of FIG. 2 according to one embodiment of the present disclosure;

FIG. 5 illustrates a cellular network including a base station that includes a SER according to one embodiment of the present disclosure;

FIG. 6 illustrates the base station of FIG. 5 in more detail according to one embodiment of the present disclosure;

FIG. 7 illustrates the base station of FIG. 5 according to another embodiment of the present disclosure; and

FIGS. 8 through 10 illustrate example simulation results.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

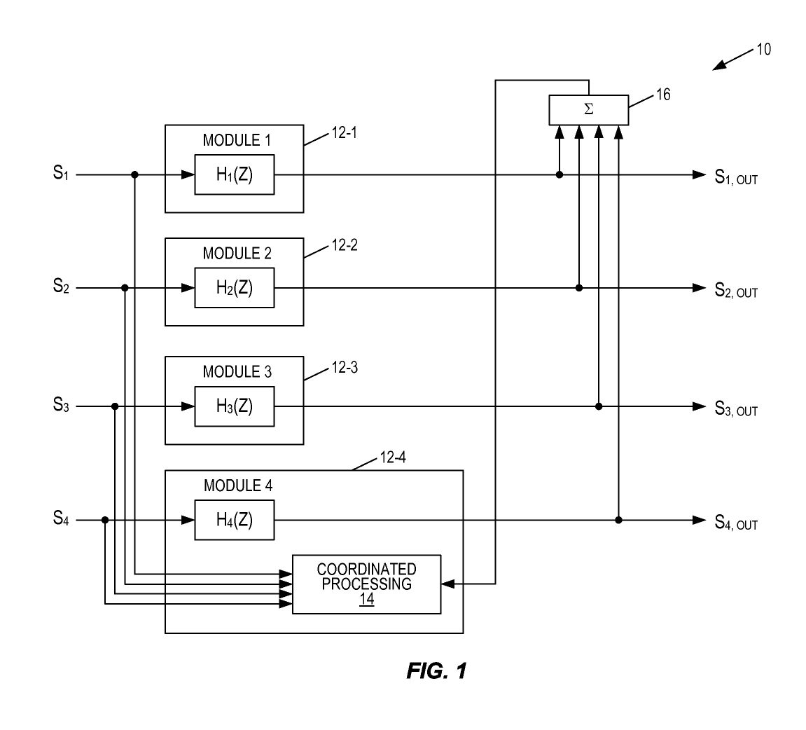

Systems and methods are disclosed for estimating impulse responses of multiple channels, e.g., multiple sub-array paths of a base station having an antenna array including multiple antenna sub-arrays, in a distributed manner. Before discussing embodiments of the present disclosure, a brief description of a centralized architecture for estimating impulse responses of multiple channels is beneficial. In this regard, FIG. 1 illustrates a centralized architecture 10 that includes multiple modules 12-1 through 12-4 (generally referred to herein collectively as modules 12 or individually as module 12) that define channels having corresponding impulse responses H₁(z) through H₄(z). In the centralized architecture 10, one of the modules 12, which in this example is the module 12-4, includes a coordinated processing component 14 that estimates the impulse responses H₁(z) through H₄(z) in a coordinated, or joint, manner. More specifically, the modules 12-1 through 12-4 receive input signals S₁ through S₄ and produce output signals S_{1,OUT} through S_{4,OUT}, respectively. The coordinated processing component 14 estimates the impulse responses H₁(z) through H₄(z) based on the input signals S₁ through S₄ (as reference signals) and a combined feedback signal output by a summation component 16. The combined feedback signal is a summation of the output signals S_{1,OUT} through S_{4,OUT}.

One issue with the centralized architecture 10 of FIG. 1 is that many interconnects are required for the module 12-4 including the coordinated processing component 14. In particular, as the number of modules 12 increases, the number of interconnects required for the module 12-4 also increases. Since the module 12-4 must have a limited number of interconnects, the number of modules 12 is also limited. Another issue is that, if the modules 12 are to be interchangeable, each of the modules 12 must include the coordinated processing component 14 even though the coordinated processing component 14 of only one of the modules 12, which again in this example is the module 12-4, is used. This significantly increases the complexity and cost of the modules 12.

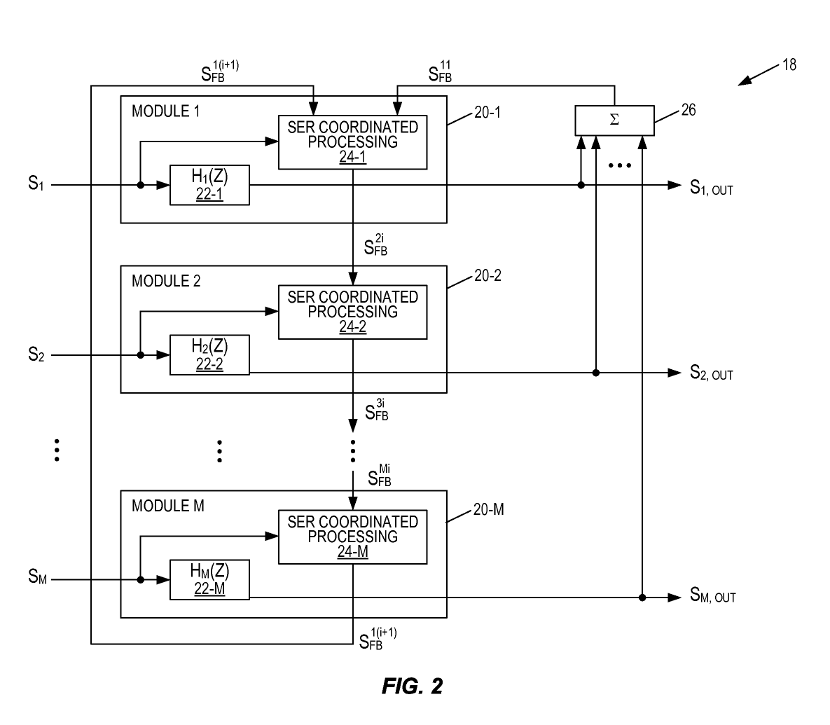

Systems and methods disclosed herein utilize a distributed architecture for estimating impulse responses of multiple channels. The distributed architecture decreases complexity and improves modularity as compared to a centralized architecture such as that of FIG. 1. In this regard, FIG. 2 illustrates a system 18 implementing a distributed architecture including multiple modules 20-1 through 20-M (generally referred to herein collectively as modules 20 and individually as module 20) according to one embodiment of the present disclosure. The modules 20 include a number of hardware components that form corresponding channels 22-1 through 22-M (generally referred to herein collectively as channels 22 and individually as a channel 22). The channels 22-1 through 22-M have corresponding impulse responses H₁(z) through H_{M}(z) (hereafter referred to as H₁ through H_{M}) that transform input signals S₁ through S_{M} into output signals S_{1,OUT} through S_{M,OUT}, respectively. As discussed below, in one embodiment, the channels 22 are sub-array paths (e.g., transmit paths or receive paths) of a base station for a cellular network, where the base station includes an antenna array including multiple sub-arrays and each sub-array path is connected to a corresponding, or different, sub-array. However, the concepts disclosed herein may also be applied to other types of systems where impulse responses for multiple channels are desired to be estimated based on a combined feedback signal.

The modules 20-1 through 20-M include Scalable Estimation Ring (SER) coordinated processing components 24-1 through 24-M, respectively, that form a SER. The SER coordinated processing components 24-1 through 24-M are generally referred to herein collectively as SER coordinated processing components 24 and individually as SER coordinated processing component 24. The SER coordinated processing components 24 forming the SER operate to estimate the impulse responses H₁ through H_{M} of the channels 22 in a distributed manner. In particular, the SER coordinated processing component 24-1 estimates the impulse response H₁ of the corresponding channel 22-1, the SER coordinated processing component 24-2 estimates the impulse response H₂ of the corresponding channel 22-2, etc.

As described below in detail, multiple iterations of the SER are performed to estimate the impulse responses H₁ through H_{M} of the channels 22-1 through 22-M based on a combined feedback signal S_{FB}¹¹. A summation component 26 operates to sum the output signals S_{1,OUT} through S_{M,OUT} to provide the combined feedback signal S_{FB}¹¹. During a first iteration of the SER, the SER performs a sequential procedure by which the SER coordinated processing components 24-1 through 24-M sequentially estimate the impulse responses H₁ through H_{M} of the corresponding channels 22-1 through 22-M and remove, or subtract, the contributions of the corresponding channels 22-1 through 22-M from the combined feedback signal S_{FB}¹¹ based on the estimates of the impulse responses H₁ through H_{M}, respectively. In this manner, as feedback signals are propagated through the SER for the first iteration, the SER coordinated processing component 24 of each module 20 has a better signal to noise ratio because a portion of the noise in the combined feedback signal S_{FB}¹¹ as seen by the SER coordinated processing component 24 of that module 20 has been removed by the SER coordinated processing component 24 of the previous module 20. At the end of the first iteration, the contributions of all of the channels 22-1 through 22-M have been removed from the combined feedback signal S_{FB}¹¹ based on initial estimates of the impulse responses H₁ through H_{M} to thereby provide a feedback signal S_{FB}¹² (i.e., S_{FB}¹⁽ⁱ⁺¹⁾ where i=1 for the first iteration) returned to the SER coordinated processing component 24-1 for the second iteration of the SER.

During the second iteration of the SER, the SER performs a sequential procedure by which each SER coordinated processing component 24-m (where mε{1, 2, . . . , M}) operates to: (a) add the contribution of the corresponding channel 22-m removed during the first iteration based on the initial estimate of the corresponding impulse response Hₘ back into the feedback signal S_{FB}^{m2} received by the SER coordinated processing component 24-m to provide a modified feedback signal S_{FB}^{m2}′, (b) compute a new estimate Hₘ₂ of the impulse response Hₘ of the corresponding channel 22-m based on the modified feedback signal S_{FB}^{m2}′ and the input signal Sₘ, and (c) remove a contribution of the corresponding channel 22-m from the modified feedback signal S_{FB}^{m2}′ based on the new estimate Hₘ₂ of the corresponding impulse response Hₘ to thereby provide a new feedback signal for a next SER coordinated processing component 24 in the SER. The process can continue in this manner to perform one or more additional iterations of the SER to, e.g., achieve a desired accuracy for the estimates of the impulse responses H₁ through H_{M}.

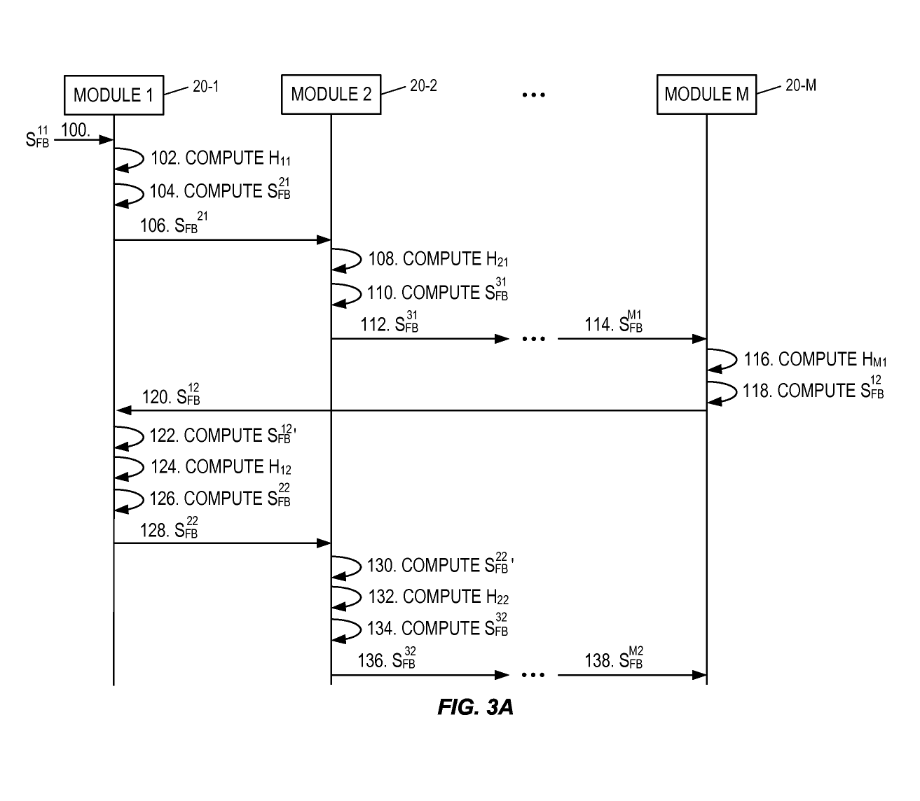

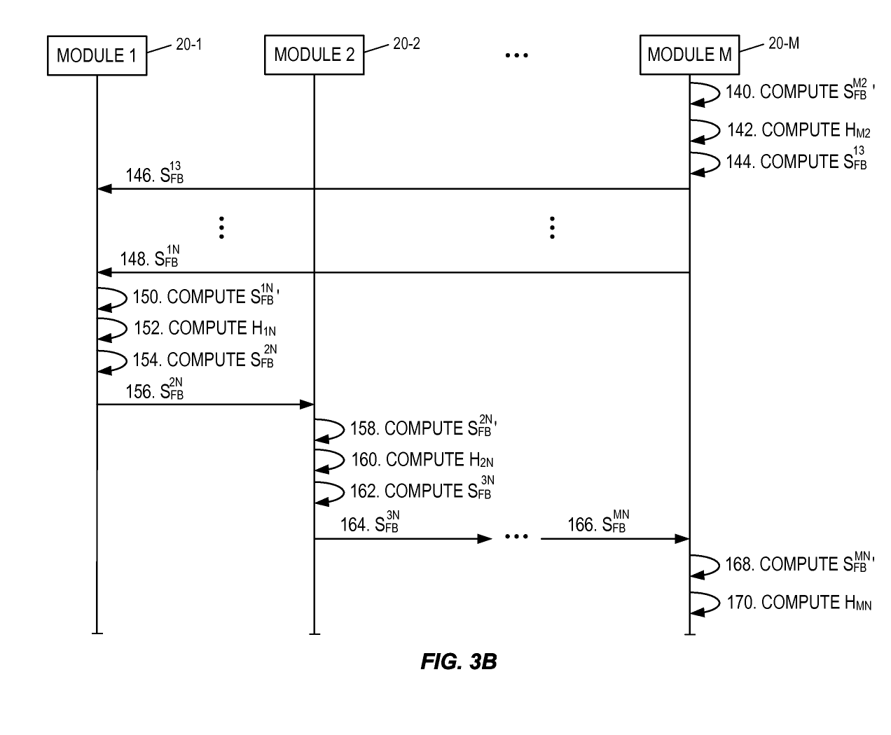

FIGS. 3A and 3B illustrate the operation of the system 18 of FIG. 2, and in particular the SER, to estimate the impulse responses H₁ through H_{M} of the channels 22-1 through 22-M, respectively, according to one embodiment of the present disclosure. For an initial or first iteration of the SER, the SER coordinated processing component 24-1 receives the combined feedback signal S_{FB}¹¹ (step 100). The combined feedback signal S_{FB}¹¹ can be defined as:

$${S}_{FB}^{11} = {\sum }_{m = 1}^{M} {S}_{m} * {H}_{m} + noise$$

where * denotes convolution. The SER coordinated processing component 24-1 of the module 20-1 then computes an estimate of the impulse response H₁ of the channel 22-1 for the first iteration, which is referred to as the estimate H₁₁ of the impulse response H₁ of the channel 22-1, based on the combined feedback signal S_{FB}¹¹ and the input signal S₁ (step 102). During the first iteration, since S₂*H₂, . . . , S_{M}*H_{M} are completely unknown to the module 20-1 and have not yet been removed by the SER coordinated processing components 24-2 through 24-M, respectively, the estimate H₁₁ of the impulse response H₁ of the channel 22-1 is generally a less than ideal estimate. However, as discussed below, the estimate is improved by using additional iterations of the SER. The estimate H₁₁ is computed as a de-convolution of time-aligned versions the combined feedback signal S_{FB}¹¹ and the input signal S₁. More specifically, this de-convolution may be computed as, for example, dividing the combined feedback signal S_{FB}¹¹ by the input signal S₁ in the frequency domain after time-alignment.

The SER coordinated processing component 24-1 of the module 20-1 then removes a contribution of the channel 22-1 from the combined feedback signal S_{FB}¹¹ to thereby provide a feedback signal S_{FB}²¹ the next SER coordinated processing component 24 in the SER, which is the SER coordinated processing component 24-2 (step 104). More specifically, the SER coordinated processing component 24-1 removes the contribution of the channel 22-1 to provide the feedback signal S_{FB}²¹ to the equation:

S_{FB}²¹=S_{FB}¹¹−(S₁*H₁₁).

The SER coordinated processing component 24-1 of the module 20-1 then outputs the feedback signal S_{FB}²¹ the SER coordinated processing component 24-2 of the module 20-2 (step 106). In this embodiment, the SER coordinated processing component 24-1 of the module 20-1 outputs the feedback signal S_{FB}²¹ directly to the SER coordinated processing component 24-2 of the module 20-2. However, in another embodiment, the SER coordinated processing component 24-1 of the module 20-1 outputs the feedback signal S_{FB}²¹ the SER coordinated processing component 24-2 of the module 20-2 via one or more other components (e.g., a controller or a baseband unit).

Likewise, upon receiving the feedback signal S_{FB}²¹, the SER coordinated processing component 24-2 of the module 20-2 then computes an estimate of the impulse response H₂ of the channel 22-2 for the first iteration, which is referred to as the estimate H₂₁ of the impulse response H₂ of the channel 22-2, based on the feedback signal S_{FB}²¹ the input signal S₂ (step 108). During the first iteration, since S₃*H₃, . . . , S_{M}*H_{M} are completely unknown to the module 20-2 and have not yet been removed by the SER coordinated processing components 24-3 through 24-M, respectively, the estimate H₂₁ of the impulse response H₂ of the channel 22-2 is generally a less than ideal estimate. However, as discussed blow, the estimate is improved by using additional iterations of the SER. Further, since S₁*H₁₁ has been removed, the estimate H₂₁ of the impulse response H₂ of the channel 22-2 is less noisy than the estimate H₁₁ of the impulse response H₁ of the channel 22-1. The estimate H₂₁ is computed as a de-convolution of time-aligned versions the feedback signal S_{FB}²¹ and the input signal S₂. More specifically, this de-convolution may be computed as, for example, dividing the feedback signal S_{FB}²¹ by the input signal S₂ in the frequency domain after time-alignment.

The SER coordinated processing component 24-2 of the module 20-2 then removes a contribution of the channel 22-2 from the feedback signal S_{FB}²¹ to thereby provide a feedback signal S_{FB}³¹ for the next SER coordinated processing component 24 in the SER, which is the SER coordinated processing component 24-3 (not shown) (step 110). More specifically, the SER coordinated processing component 24-2 removes the contribution of the channel 22-2 to provide the feedback signal S_{FB}³¹ according to the equation:

S_{FB}³¹=S_{FB}²¹−(S₂*H₂₁).

The SER coordinated processing component 24-2 of the module 20-2 then outputs the feedback signal S_{FB}³¹ (for the SER coordinated processing component 24-3 of the module 20-3, which are not shown) (step 112). Note that the module 20-3 is the last module 20-M in the case M=3. In this embodiment, the SER coordinated processing component 24-2 of the module 20-2 outputs the feedback signal S_{FB}³¹ directly to the SER coordinated processing component 24-3 of the module 20-3. However, in another embodiment, the SER coordinated processing component 24-2 of the module 20-2 outputs the feedback signal S_{FB}³¹ to the SER coordinated processing component 24-3 of the module 20-3 via one or more other components (e.g., a controller or a baseband unit).

The first iteration of the SER continues in this manner until the SER coordinated processing component 24-M receives a feedback signal S_{FB}^{M1} from its preceding SER coordinated processing component 24-(M−1) in the SER (step 114). Upon receiving the feedback signal S_{FB}^{M1}, the SER coordinated processing component 24-M of the module 20-M computes an estimate of the impulse response H_{M} of the channel 22-M for the first iteration, which is referred to as the estimate H_{M1} of the impulse response H_{M} of the channel 22-M, based on the feedback signal S_{FB}^{M1} and the input signal S_{M} (step 116). Since the estimated contributions S₁H*H₁₁, . . . , S_{(M-1)}*H_{(M-1)1} of the channels 22-1 through 22-(M−1) have been removed, the estimate H_{M1} of the impulse response H_{M} of the channel 22-M is less noisy than the other estimates H₁₁ through H_{(M-1),1} of the impulse responses H₁ through H_{(M-1)} of the channels 22-1 through 22-(M−1), respectively. The estimate H_{M1} is computed as a de-convolution of time-aligned versions of the feedback signal S_{FB}^{M1} and the input signal S_{M}. More specifically, this de-convolution may be computed as, for example, dividing the feedback signal S_{FB}^{M1} by the input signal S_{M} in the frequency domain after time-alignment.

The SER coordinated processing component 24-M of the module 20-M then removes a contribution of the channel 22-M from the feedback signal S_{FB}^{M1} to thereby provide a feedback signal S_{FB}¹² for the next SER coordinated processing component 24 in the SER, which is the SER coordinated processing component 24-1 (i.e., the feedback signal S_{FB}¹² is the feedback signal for the SER coordinated processing component 24-1 for a second iteration of the SER) (step 118). More specifically, the SER coordinated processing component 24-M removes the contribution of the channel 22-M to provide the feedback signal S_{FB}¹² according to the equation:

S_{FB}¹²=S_{FB}^{M1}−(S_{M}*H_{M1}).

The SER coordinated processing component 24-M of the module 20-M then outputs the feedback signal S_{FB}¹² for the SER coordinated processing component 24-1 of the module 20-1 (step 120). In this embodiment, the SER coordinated processing component 24-M of the module 20-M outputs the feedback signal S_{FB}¹² directly to the SER coordinated processing component 24-1 of the module 20-1. However, in another embodiment, the SER coordinated processing component 24-M of the module 20-M outputs the feedback signal S_{FB}¹² to the SER coordinated processing component 24-1 of the module 20-1 via one or more other components (e.g., a controller or a baseband unit). At this point, the first iteration of the SER is complete.

Next, a second iteration of the SER is performed. In the second iteration of the SER, the SER coordinated processing component 24-1 of the module 20-1 first adds the contribution of the channel 22-1 removed in the previous iteration of the SER back into the feedback signal S_{FB}¹² to thereby provide a modified feedback signal S_{FB}¹²′ (step 122). More specifically, the feedback signal S_{FB}¹² can be expressed as:

$${S}_{FB}^{12} = {\sum }_{m = 1}^{M} {S}_{m} * ( {H}_{m} - {H}_{m 1} ) + noise .$$

The SER coordinated processing component 24-1 can then add the contribution of the channel 22-1 removed in the previous iteration of the SER (i.e., S₁*H₁₁) back into the feedback signal S_{FB}¹² to thereby provide the modified feedback signal S_{FB}¹²′ according to:

$$\begin{matrix}{S}_{FB}^{{12}^{′}} = {S}_{FB}^{12} + {S}_{1} * {H}_{11} \\ = {S}_{1} * {H}_{1} + {\sum }_{m = 2}^{M} {S}_{m} * ( {H}_{m} - {H}_{m 1} ) + noise\end{matrix}$$

The SER coordinated processing component 24-1 of the module 20-1 then computes a new estimate H₁₂ of the impulse response H₁ of the channel 22-1 for the second iteration, which is referred to as the estimate H₁₂ of the impulse response H₁ of the channel 22-1, based on the modified feedback signal S_{FB}¹²′ and the input signal S₁ (step 124). Since the estimated contributions S₂*H₂₁, . . . , S_{M}*H_{M1} of the channels 22-2 through 22-M were removed in the initial iteration, the estimate H₁₂ of the impulse response H₁ of the channel 22-1 for the second iteration is less noisy (i.e., improved) than the estimate H₁₁ of the impulse response H₁ of the channel 22-1 for the first iteration. The estimate H₁₂ is computed as a de-convolution of time-aligned versions of the modified feedback signal S_{FB}¹²′ and the input signal S₁. More specifically, this de-convolution may be computed as, for example, dividing the modified feedback signal S_{FB}¹²′ by the input signal S₁ in the frequency domain after time-alignment.

The SER coordinated processing component 24-1 of the module 20-1 then removes a contribution of the channel 22-1 from the modified feedback signal S_{FB}¹²′ to thereby provide a feedback signal S_{FB}²² for the next SER coordinated processing component 24 in the SER, which is the SER coordinated processing component 24-2 (step 126). More specifically, the SER coordinated processing component 24-1 removes the contribution of the channel 22-1 to provide the feedback signal S_{FB}²² according to the equation:

S_{FB}²²=S_{FB}¹²′−(S₁*H₁₂).

The SER coordinated processing component 24-1 of the module 20-1 then outputs the feedback signal S_{FB}²² for the SER coordinated processing component 24-2 of the module 20-2 (step 128). In this embodiment, the SER coordinated processing component 24-1 of the module 20-1 outputs the feedback signal S_{FB}²² directly to the SER coordinated processing component 24-2 of the module 20-2. However, in another embodiment, the SER coordinated processing component 24-1 of the module 20-1 outputs the feedback signal S_{FB}²² to the SER coordinated processing component 24-2 of the module 20-2 via one or more other components (e.g., a controller or a baseband unit).

Likewise, upon receiving the feedback signal S_{FB}²²′ the SER coordinated processing component 24-2 of the module 20-2 adds the contribution of the channel 22-2 removed in the previous iteration of the SER back into the feedback signal S_{FB}²² to thereby provide a modified feedback signal S_{FB}²²′ (step 130). More specifically, the feedback signal S_{FB}²² can be expressed as:

$${S}_{FB}^{22} = {S}_{1} * ( {H}_{1} - {H}_{12} ) + {\sum }_{m = 2}^{M} {S}_{m} * ( {H}_{m} - {H}_{m 1} ) + noise .$$

The SER coordinated processing component 24-2 can then add the contribution of the channel 22-2 removed in the previous iteration of the SER (i.e., S₂*H₂₁) back into the feedback signal S_{FB}²² to thereby provide the modified feedback signal S_{FB}²²′ according to:

$$\begin{matrix}{S}_{FB}^{{22}^{′}} = {S}_{FB}^{22} + {S}_{2} * {H}_{21} \\ = {S}_{1} * ( {H}_{1} - {H}_{12} ) + {S}_{2} * {H}_{2} + {\sum }_{m = 3}^{M} {S}_{m} * ( {H}_{m} - {H}_{m 1} ) + noise\end{matrix}$$

The SER coordinated processing component 24-2 of the module 20-2 then computes a new estimate of the impulse response H₂ of the channel 22-2 for the second iteration, which is referred to as the estimate H₂₂ of the impulse response H₂ of the channel 22-2, based on the modified feedback signal S_{FB}²²′ and the input signal S₂ (step 132). Since the estimated contribution S₁*H₁₂ of the channel 22-1 has already been removed in the second iteration and the estimated contributions S₃*H₃₁, . . . , S_{M}*H_{M1} of the channels 22-3 through 22-M were removed in the initial iteration, the estimate H₂₂ of the impulse response H₂ of the channel 22-2 for the second iteration is less noisy (i.e., improved) than the estimate H₂₁ of the impulse response H₂ of the channel 22-2 for the first iteration. The estimate H₂₂ is computed as a de-convolution of time-aligned versions of the modified feedback signal S_{FB}²²′ and the input signal S₂. More specifically, this de-convolution may be computed as, for example, dividing the modified feedback signal S_{FB}²²′ by the input signal S₂ in the frequency domain after time-alignment.

The SER coordinated processing component 24-2 of the module 20-2 then removes a contribution of the channel 22-2 from the modified feedback signal S_{FB}²²′ to thereby provide a feedback signal S_{FB}³² for the next SER coordinated processing component 24 in the SER, which is the SER coordinated processing component 24-3 (step 134). More specifically, the SER coordinated processing component 24-2 removes the contribution of the channel 22-2 to provide the feedback signal S_{FB}³² according to the equation:

S_{FB}³²=S_{FB}²²′−(S₂*H₂₂).

The SER coordinated processing component 24-2 of the module 20-2 then outputs the feedback signal S_{FB}³² for the SER coordinated processing component 24-3 of the module 20-3 (not shown) (step 136). In this embodiment, the SER coordinated processing component 24-2 of the module 20-2 outputs the feedback signal S_{FB}³² directly to the SER coordinated processing component 24-3 of the module 20-3 (again, not shown). However, in another embodiment, the SER coordinated processing component 24-2 of the module 20-2 outputs the feedback signal S_{FB}³² to the SER coordinated processing component 24-3 of the module 20-3 via one or more other components (e.g., a controller or a baseband unit).

The second iteration of the SER continues in this manner until the final SER coordinated processing component 24-M of the final module 20-M receives a feedback signal S_{FB}^{M2} from its preceding SER coordinated processing component 24-(M−1) in the SER (step 138). Upon receiving the feedback signal S_{FB}^{M2}, the SER coordinated processing component 24-M of the module 20-M adds the contribution of the channel 22-M removed in the previous iteration of the SER back into the feedback signal S_{FB}^{M2} to thereby provide a modified feedback signal S_{FB}^{M2}′ (step 140). More specifically, the feedback signal S_{FB}^{M2} can be expressed as:

$${S}_{FB}^{M 2} = {\sum }_{m = 1}^{M - 1} {S}_{m} * ( {H}_{m} - {H}_{m 2} ) + {S}_{M} * ( {H}_{m} - {H}_{M 1} ) + noise .$$

The SER coordinated processing component 24-M can then add the contribution of the channel 22-M removed in the previous iteration of the SER (i.e., S_{M}*H_{M1}) back into the feedback signal S_{FB}^{M2} to thereby provide the modified feedback signal S_{FB}^{M2′} according to:

$${S}_{FB}^{M {2}^{′}} = {\sum }_{m = 1}^{M - 1} {S}_{m} * ( {H}_{m} - {H}_{m 2} ) + {S}_{M} * {H}_{M} + noise .$$

The SER coordinated processing component 24-M of the module 20-M then computes a new estimate of the impulse response H_{M} of the channel 22-M for the second iteration, which is referred to as the estimate H_{M2} of the impulse response H_{M} of the channel 22-M, based on the modified feedback signal S_{FB}^{M2}′ and the input signal S_{M} (step 142). Since the new (and improved) estimated contributions S₁H*H₁₂, . . . , S_{(M-1)}*H_{(M-1)2} of the channels 22-1 through 22-(M−1) for the second iteration have been removed, the estimate H_{M2} of the impulse response H_{M} of the channel 22-M is improved. The estimate H_{M2} is computed as a de-convolution of time-aligned versions of the modified feedback signal S_{FB}^{M2}′ and the input signal S_{M}. More specifically, this de-convolution may be computed as, for example, dividing the modified feedback signal S_{FB}^{M2′} by the input signal S_{M} in the frequency domain after time-alignment.

The SER coordinated processing component 24-M of the module 20-M then removes a contribution of the channel 22-M from the modified feedback signal S_{FB}^{M2}′ to thereby provide a feedback signal S_{FB}¹³ for the next SER coordinated processing component 24 in the SER, which is the SER coordinated processing component 24-1 (step 144). In this case, the feedback signal S_{FB}¹³ is a feedback signal for the SER coordinated processing component 24-1 of the module 20-1 for a third iteration of the SER. More specifically, the SER coordinated processing component 24-M removes the contribution of the channel 22-M to provide the feedback signal S_{FB}¹³ according to the equation:

S_{FB}¹³=S_{FB}^{M2′}−(S_{M}*H_{M2}).

The SER coordinated processing component 24-M of the module 20-M then outputs the feedback signal S_{FB}¹³ for the SER coordinated processing component 24-1 of the module 20-1 (step 146). In this embodiment, the SER coordinated processing component 24-M of the module 20-M outputs the feedback signal S_{FB}¹³ directly to the SER coordinated processing component 24-M of the module 20-M. However, in another embodiment, the SER coordinated processing component 24-M of the module 20-M outputs the feedback signal S_{FB}¹³ to the SER coordinated processing component 24-1 of the module 20-1 via one or more other components (e.g., a controller or a baseband unit).

Iterations of the SER continue in this manner until a final iteration of the SER is reached. Note that the desired number of iterations is, in one embodiment, greater than or equal to 2. In another embodiment, the number of iterations is greater than or equal to 8. Note that the number of iterations performed is, in one embodiment, a tradeoff between accuracy and time.

In the final iteration, the SER coordinated processing component 24-1 of the module 20-1 receives a feedback signal S_{FB}^{1N} from the SER coordinated processing component 24-M of the module 20-M, where N is the number of iterations performed by the SER (step 148). Upon receiving the feedback signal S_{FB}^{1N}, the SER coordinated processing component 24-1 of the module 20-1 adds the contribution of the channel 22-1 removed in the previous iteration (i.e., the (N−1)th iteration) of the SER back into the feedback signal S_{FB}^{1N} to thereby provide a modified feedback signal S_{FB}^{1N}′ (step 150). More specifically, the feedback signal S_{FB}^{1N} can be expressed as:

$${S}_{FB}^{1 N} = {\sum }_{m = 1}^{M} {S}_{m} * ( {H}_{m} - {H}_{m ( N - 1 )} ) + noise .$$

The SER coordinated processing component 24-1 can then add the contribution of the channel 22-1 removed in the previous iteration of the SER (i.e., S₁*H_{1(N-1)}) back into the feedback signal S_{FB}^{1N} to thereby provide the modified feedback signal S_{FB}^{1N}′ according to:

$$\begin{matrix}{S}_{FB}^{1 {N}^{′}} = {S}_{FB}^{1 N} + {S}_{1} * {H}_{1 ( N - 1 )} \\ = {S}_{1} * {H}_{1} + {\sum }_{m = 2}^{M} {S}_{m} * ( {H}_{m} - {H}_{m ( N - 1 )} ) + noise\end{matrix}$$

The SER coordinated processing component 24-1 of the module 20-1 then computes a new estimate of the impulse response H₁ of the channel 22-1 for the Nth iteration, which is referred to as the estimate H_{1N} of the impulse response H₁ of the channel 22-1, based on the modified feedback signal S_{FB}^{1N}′ and the input signal S₁ (step 152). The estimate H_{1N} is computed as a de-convolution of time-aligned versions of the modified feedback signal S_{FB}^{1N}′ and the input signal S₁. More specifically, this de-convolution may be computed as, for example, dividing the modified feedback signal S_{FB}^{1N}′ by the input signal S₁ in the frequency domain after time-alignment.

The SER coordinated processing component 24-1 of the module 20-1 then removes a contribution of the channel 22-1 from the modified feedback signal S_{FB}^{1N}′ to thereby provide a feedback signal S_{FB}^{2N} for the next SER coordinated processing component 24 in the SER, which is the SER coordinated processing component 24-2 (step 154). More specifically, the SER coordinated processing component 24-1 removes the contribution of the channel 22-1 to provide the feedback signal S_{FB}^{2N} according to the equation:

S_{FB}^{2N}=S_{FB}^{1N}′−(S₁*H_{1N}).

The SER coordinated processing component 24-1 of the module 20-1 then outputs the feedback signal S_{FB}^{2N} for the SER coordinated processing component 24-2 of the module 20-2 (step 156). In this embodiment, the SER coordinated processing component 24-1 of the module 20-1 outputs the feedback signal S_{FB}^{2N} directly to the SER coordinated processing component 24-2 of the module 20-2. However, in another embodiment, the SER coordinated processing component 24-1 of the module 20-1 outputs the feedback signal S_{FB}^{2N} to the SER coordinated processing component 24-2 of the module 20-2 via one or more other components (e.g., a controller or a baseband unit).

Likewise, upon receiving the feedback signal S_{FB}^{2N}, the SER coordinated processing component 24-2 of the module 20-2 adds the contribution of the channel 22-2 removed in the previous iteration (i.e., the (N−1)th iteration) of the SER back into the feedback signal S_{FB}^{2N} to thereby provide a modified feedback signal S_{FB}^{2N}′ (step 158). More specifically, the feedback signal S_{FB}^{2N} can be expressed as:

$${S}_{FB}^{2 N} = {S}_{1} * ( {H}_{1} - {H}_{1 N} ) + {\sum }_{m = 2}^{M} {S}_{m} * ( {H}_{m} - {H}_{m ( N - 1 )} ) + noise .$$

The SER coordinated processing component 24-2 can then add the contribution of the channel 22-2 removed in the previous iteration of the SER (i.e., S₂*H_{2(N-1)}) back into the feedback signal S_{FB}^{2N} to thereby provide the modified feedback signal S_{FB}^{2N}′ according to:

$$\begin{matrix}{S}_{FB}^{2 {N}^{′}} = {S}_{FB}^{2 N} + {S}_{2} * {H}_{2 ( N - 1 )} \\ = {S}_{1} * ( {H}_{1} - {H}_{1 N} ) + {S}_{2} * {H}_{2} + {\sum }_{m = 3}^{M} {S}_{m} * ( {H}_{m} - {H}_{m ( N - 1 )} ) + noise\end{matrix}$$

The SER coordinated processing component 24-2 of the module 20-2 then computes a new estimate of the impulse response H₂ of the channel 22-2 for the Nth iteration, which is referred to as the estimate H_{2N} of the impulse response H₂ of the channel 22-2, based on the modified feedback signal S_{FB}^{2N}′ and the input signal S₂ (step 160). The estimate H_{2N} is computed as a de-convolution of time-aligned versions of the modified feedback signal S_{FB}^{2N}′ and the input signal S₂. More specifically, this de-convolution may be computed as, for example, dividing the modified feedback signal S_{FB}^{2N}′ by the input signal S₂ in the frequency domain after time-alignment.

The SER coordinated processing component 24-2 of the module 20-2 then removes a contribution of the channel 22-2 from the modified feedback signal S_{FB}^{2N}′ to thereby provide a feedback signal S_{FB}^{3N} for the next SER coordinated processing component 24 in the SER, which is the SER coordinated processing component 24-3 (step 162). More specifically, the SER coordinated processing component 24-2 removes the contribution of the channel 22-2 to provide the feedback signal S_{FB}^{3N} according to the equation:

S_{FB}^{3N}=S_{FB}^{2N}′−(S₂*H_{2N}).

The SER coordinated processing component 24-2 of the module 20-2 then outputs the feedback signal S_{FB}^{3N} for the SER coordinated processing component 24-3 of the module 20-3 (not shown) (step 164). In this embodiment, the SER coordinated processing component 24-2 of the module 20-2 outputs the feedback signal S_{FB}^{3N} directly to the SER coordinated processing component 24-3 of the module 20-3 (again, not shown). However, in another embodiment, the SER coordinated processing component 24-2 of the module 20-2 outputs the feedback signal S_{FB}^{3N} to the SER coordinated processing component 24-3 of the module 20-3 via one or more other components (e.g., a controller or a baseband unit).

The Nth (or final) iteration of the SER continues in this manner until the final SER coordinated processing component 24-M of the final module 20-M receives a feedback signal S_{FB}^{MN} from its preceding SER coordinated processing component 24-(M−1) in the SER (step 166). Upon receiving the feedback signal S_{FB}^{MN}, the SER coordinated processing component 24-M of the module 20-M adds the contribution of the channel 22-M removed in the previous iteration (i.e., the (N−1)th iteration) of the SER back into the feedback signal S_{FB}^{MN} to thereby provide a modified feedback signal S_{FB}^{MN}′ (step 168). More specifically, the feedback signal S_{FB}^{MN} can be expressed as:

$${S}_{FB}^{MN} = {\sum }_{m = 1}^{M - 1} {S}_{m} * ( {H}_{m} - {H}_{mN} ) + {S}_{M} * ( {H}_{M} - {H}_{M ( N - 1 )} ) + noise .$$

The SER coordinated processing component 24-M can then add the contribution of the channel 22-M removed in the previous iteration of the SER (i.e., S_{M}*H_{M(N-1)}) back into the feedback signal S_{FB}^{MN} to thereby provide the modified feedback signal S_{FB}^{MN}′ according to:

$${S}_{FB}^{{MN}^{′}} = {\sum }_{m = 1}^{M - 1} {S}_{m} * ( {H}_{m} - {H}_{mN} ) + {S}_{M} * {H}_{M} + noise .$$

The SER coordinated processing component 24-M of the module 20-M then computes a new estimate of the impulse response H_{M} of the channel 22-M for the Nth iteration, which is referred to as the estimate H_{MN} of the impulse response H_{M} of the channel 22-M, based on the modified feedback signal S_{FB}^{MN}, and the input signal S_{M} (step 170). The estimate H_{MN} is computed as a de-convolution of time-aligned versions of the modified feedback signal S_{FB}^{MN}′ and the input signal S_{M}. More specifically, this de-convolution may be computed as, for example, dividing the modified feedback signal S_{FB}^{MN}′ by the input signal S_{M} in the frequency domain after time-alignment.

At this point, the process is complete. The estimates H_{1N} through H_{MN} are the final estimates of the impulse responses H₁ through H_{M} of the channels 22-1 through 22-M, respectively. The final estimates of the impulse responses H₁ through H_{M} of the channels 22-1 through 22-M can then be used to correct or compensate for linear distortions (i.e., to equalize) the channels 22-1 through 22-M. Notably, during operation, the process of FIGS. 3A and 3B may be repeated as desired in order to update the final estimates of the impulse responses H₁ through H_{M} of the channels 22-1 through 22-M over time in order to account for changes in the impulse responses H₁ through H_{M} of the channels 22-1 through 22-M.

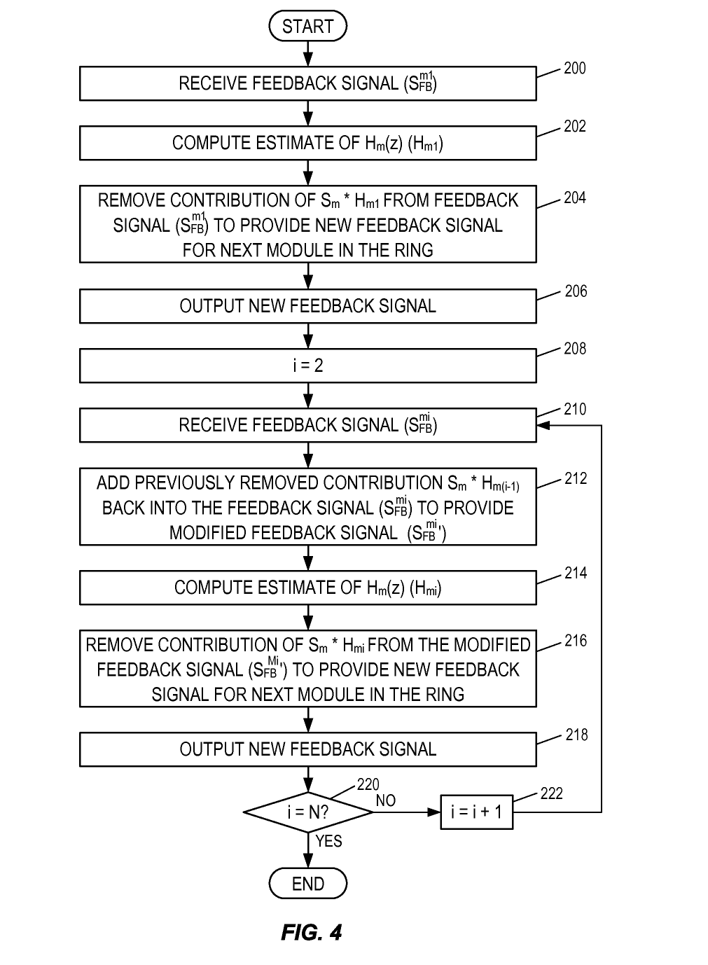

FIG. 4 is a flow chart that illustrates the operation of the m-th SER coordinated processing component 24-m of FIG. 2 according to one embodiment of the present disclosure. The operation of the SER coordinated processing component 24-m in this embodiment is the same as described above with respect to FIG. 3. As such, some details are not repeated. As illustrated, for the first or initial iteration of the SER, the SER coordinated processing component 24-m receives the feedback signal S_{FB}^{m1} (step 200). The SER coordinated processing component 24-m then computes the estimate Hₘ₁ of the impulse response Hₘ of the corresponding channel 22-m for the first iteration of the SER based on the feedback signal S_{FB}^{m1} and the corresponding input signal Sₘ (step 202). The SER coordinated processing component 24-m then removes the contribution of the corresponding channel Sₘ (i.e., Sₘ*Hₘ₁) from the feedback signal S_{FB}^{m1} to provide the feedback signal for the next SER coordinated processing component 24 in the SER (step 204). The SER coordinated processing component 24-m then outputs the feedback signal for the next SER coordinated processing component 24 in the SER (step 206).

In this embodiment, the SER coordinated processing component 24-m then sets an iteration counter i to 2 (step 208). Next, the SER coordinated processing component 24-m receives the feedback signal S_{FB}^{mi} for the i-th iteration of the SER from the preceding SER coordinated processing component 24 in the SER (step 210). The SER coordinated processing component 24-m then adds the contribution (i.e., Sₘ*Hₘ₍ᵢ₋₁₎) of the channel 22-m removed during the previous iteration (i.e., iteration i−1) back into the feedback signal S_{FB}^{mi} to thereby provide a modified feedback signal S_{FB}^{mi}′ (step 212). The SER coordinated processing component 24-m then computes the new estimate Hₘᵢ for the impulse response Hₘ of the channel 22-m based on the modified feedback signal S_{FB}^{mi}′ and the corresponding input signal Sₘ (step 214). Next, the SER coordinated processing component 24-m removes the contribution (i.e., Sₘ*Hₘᵢ) of the channel 22-m from the modified feedback signal S_{FB}^{mi}′ to thereby provide a new feedback signal for the next SER coordinated processing component 24 in the SER (step 216). The SER coordinated processing component 24-m then outputs the new feedback signal to the next SER coordinated processing component 24 (step 218).

The SER coordinated processing component 24-m then determines whether the desired number of iterations of the SER have been performed (i.e., determines whether i=N, where N is the desired number of iterations of the SER) (step 220). If not, the iteration counter i is incremented (step 222), and the process returns to step 210 and is repeated. Once the desired number (N) of iterations have been performed, the final estimate H_{mN} of the impulse response Hₘ of the corresponding channel 22-m has been computed, and the process ends. It should be noted that while the first and subsequent iterations of the SER are illustrated separately in the flow chart of FIG. 4, the present disclosure is not limited thereto. In another embodiment, the first iteration may be performed just like the other iterations but where the previously removed contribution that is added back into the feedback signal for the first iteration is 0.

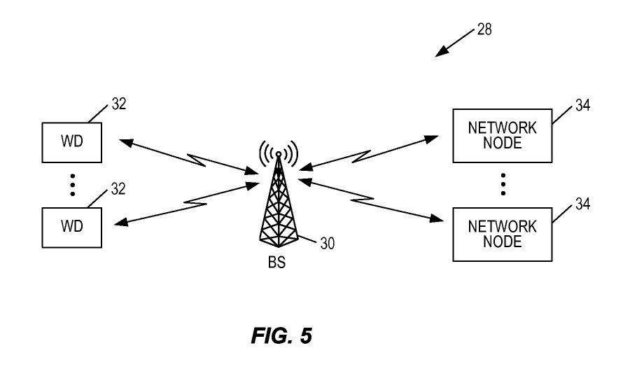

While the SER described above can be used in any suitable system, in one embodiment, the SER is used to estimate sub-array paths (e.g., transmit or receive paths) in a base station having an antenna array including multiple sub-arrays. In this regard, FIG. 5 illustrates a cellular network 28 including a base station 30 that transmits radio signals to and receives radio signals from a number of wireless devices 32 and, in some embodiments, transmits radio signals to and receives radio signals from a number of network nodes 34 (e.g., other base stations using a wireless backhaul network). The base station 30 includes an antenna array including multiple sub-arrays. Radio signals are provided to or received from the sub-arrays by corresponding channels, which are defined by corresponding sub-array paths. In one embodiment, the sub-array paths are more particularly transmit paths through which radio signals are provided to the sub-arrays for transmission. However, in another embodiment, the sub-array paths are receive paths through which radio signals received by the sub-arrays are processed. In this embodiment, the base station 30 includes a SER ring that operates to estimate impulse responses of the sub-array paths in a distributed manner.

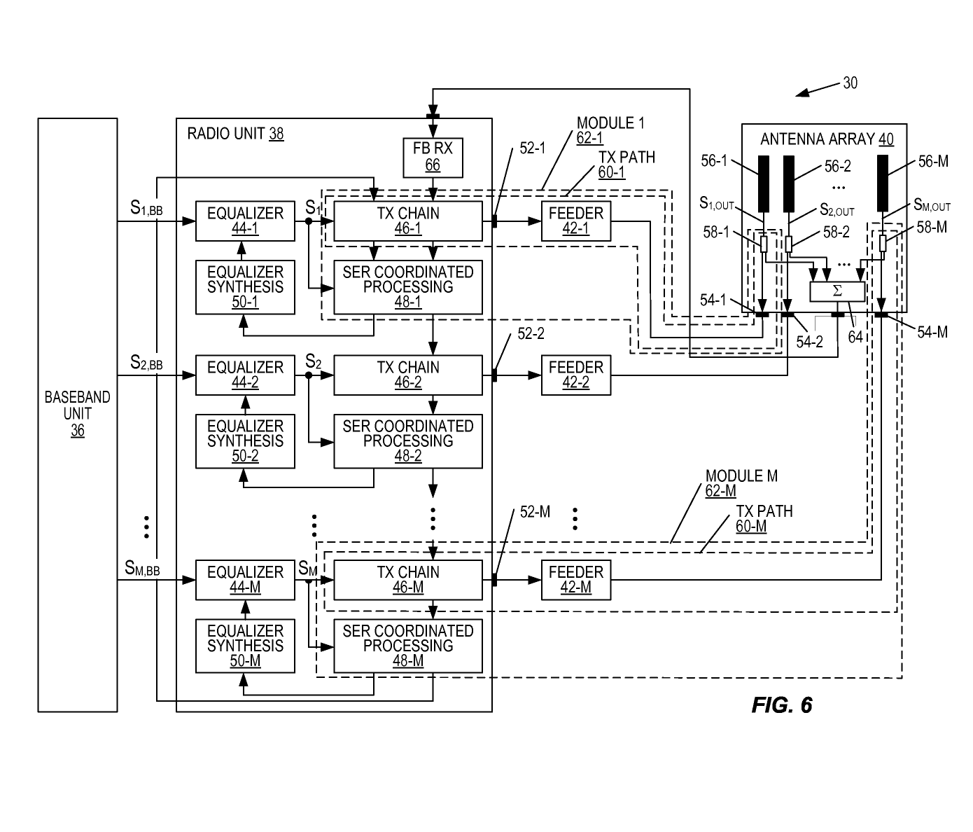

FIG. 6 illustrates the base station 30 in more detail according to one embodiment of the present disclosure. As illustrated, the base station 30 includes a baseband unit 36, a radio unit 38, an antenna array 40, and feeders 42-1 through 42-M (generally referred to herein collectively as feeders 42 and individually as a feeder 42) connected as shown. The radio unit 38 includes multiple (M) branches formed by equalizers 44-1 through 44-M and transmit chains 46-1 through 46-M. In addition, the radio unit 38 includes a SER formed by SER coordinated processing components 48-1 through 48-M, and equalizer synthesis components 50-1 through 50-M that operate to configure the equalizers 44-1 through 44-M based on estimates from the corresponding SER coordinated processing components 48-1 through 48-M.

The radio unit 38 also includes connectors 52-1 through 52-M by which outputs of the transmit chains 46-1 through 46-M are connected to first ends of the feeders 42-1 through 42-M, respectively. The feeders 42-1 through 42-M are cables that interconnect the radio unit 38 and the antenna array 40. Second ends of the feeders 42-1 through 42-M are connected to corresponding connectors 54-1 through 54-M of the antenna array 40. Within the antenna array 40, multiple sub-arrays 56-1 through 56-M are connected to the feeders 42-1 through 42-M, respectively, via corresponding couplers 58-1 through 58-M and the connectors 54-1 through 54-M.

In this embodiment, the transmit chain 46-1, the connector 52-1, the feeder 42-1, the connector 54-1, and the coupler 58-1 form a transmit path 60-1 having a corresponding impulse response H₁ by which an input signal S₁ of the transmit chain 46-1 is transformed to provide an output signal S_{1,OUT} to the corresponding sub-array 56-1. Together, the transmit path 60-1 and the SER coordinated processing component 48-1 form a first module 62-1. Likewise, the transmit chain 46-2, the connector 52-2, the feeder 42-2, the connector 54-2, and the coupler 58-2 form a transmit path having a corresponding impulse response H₂ by which an input signal S₂ of the transmit chain 46-2 is transformed to provide an output signal S_{2,OUT} to the corresponding sub-array 56-2. Together, the transmit path and the SER coordinated processing component 48-2 form a second module. In the same manner, the transmit chain 46-M, the connector 52-M, the feeder 42-M, the connector 54-M, and the coupler 58-M form a transmit path 60-M having a corresponding impulse response H_{M} by which an input signal S_{M} of the transmit chain 46-M is transformed to provide an output signal S_{M,OUT} to the corresponding sub-array 56-M. Together, the transmit path 60-M and the SER coordinated processing component 48-M form an Mth module 62-M.

In operation, the baseband unit 36 outputs baseband input signals S_{1,BB} through S_{M,BB}, which are baseband representations of radio signals to be transmitted by the base station 30. The equalizers 44-1 through 44-M process the baseband input signals S_{1,BB} through S_{M,BB} to compensate or correct for the impulse responses H₁ through H_{M} of the transmit paths 60-1 through 60-M, as estimated by the SER, and thereby provide the input signals S₁ through S_{M} of the transmit chains 46-1 through 46-M. In particular, the equalizer synthesis components 50-1 through 50-M configure the equalizers 44-1 through 44-M to apply an inverse of the estimated impulse responses of the transmit paths 60-1 through 60-M, respectively. Notably, while not illustrated, the baseband input signals S_{1,BB} through S_{M,BB} may be conditioned by corresponding conditioning component(s) prior to equalization if the baseband input signals S_{1,BB} through S_{M,BB} are correlated. In other words, the input signals S₁ through S_{M} should be uncorrelated. If they are not, then conditioning may be performed in order to remove the correlation between the input signals S₁ through S_{M}. While not essential, the interested reader can refer to U.S. patent application Ser. No. 13/894,826 for a discussion on one example conditioning process.

The input signals S₁ through S_{M} are then processed by the transmit chains 46-1 through 46-M (e.g., upconversion, amplification, filtering, etc.). The resulting radio signals are then provided to the corresponding antenna sub-arrays 56-1 through 56-M via the connectors 52-1 through 52-M, the feeders 42-1 through 42-M, the connectors 54-1 through 54-M, and the couplers 58-1 through 58-M. Significant non-linearities in the transmit paths 60-1 through 60-M (e.g., non-linearities of power amplifiers in the transmit chains 46-1 through 46-M) are typically taken care of by non-linear pre-distortion techniques. To calibrate and compensate for the linear impairment of phase and/or amplitude in the transmit paths 60-1 through 60-M, the SER operates to estimate the impulse responses H₁ through H_{M} of the transmit paths 60-1 through 60-M in the manner described above. The estimates of the impulse responses H₁ through H_{M} are then used by the equalizer synthesis components 50-1 through 50-M to set the equalizers 44-1 through 44-M to apply an inverse of the estimated impulse responses H₁ through H_{M}, respectively, and thereby correct, or compensate, for the linear impairment of phase and/or amplitude in the transmit paths 60-1 through 60-M.

In order to estimate the impulse responses H₁ through H_{M}, the SER operates in the manner described above. Specifically, for an initial or first iteration of the SER, the SER coordinated processing component 48-1 receives a combined feedback signal S_{FB}¹¹ from a summation component 64 in the antenna array 40 via a feedback receiver 66. The summation component 64 operates to sum the output signals S_{1,OUT} through S_{M,OUT}. The feedback receiver 66 operates to receive (e.g., downconvert and digitize) the combined feedback signal S_{FB}¹¹. The SER coordinated processing component 48-1 then computes an estimate of the impulse response H₁ of the transmit path 60-1 for the first iteration, which is referred to as the estimate H₁₁ of the impulse response H₁ of the transmit path 60-1, based on the combined feedback signal S_{FB}¹¹ and the input signal S₁. The SER coordinated processing component 48-1 then removes a contribution (i.e., S₁*H₁₁) of the transmit path 60-1 from the combined feedback signal S_{FB}¹¹ to thereby provide a feedback signal S_{FB}²¹ for the next SER coordinated processing component 48 in the SER, which is the SER coordinated processing component 48-2. The SER coordinated processing component 48-1 then outputs the feedback signal S_{FB}²¹ for the SER coordinated processing component 48-2.

Likewise, upon receiving the feedback signal S_{FB}²¹, the SER coordinated processing component 48-2 computes an estimate of the impulse response H₂ of the transmit path 60-2 (i.e., the transmit path formed by the transmit chain 46-2, the connector 52-2, the feeder 42-2, the connector 54-2, and the coupler 58-2) for the first iteration, which is referred to as the estimate H₂₁ of the impulse response H₂ of the transmit path 60-2, based on the feedback signal S_{FB}²¹ and the input signal S₂. The SER coordinated processing component 48-2 then removes a contribution (i.e., S₂*H₂₁) of the transmit path 60-2 from the feedback signal S_{FB}²¹ to thereby provide a feedback signal S_{FB}³¹ for the next SER coordinated processing component 48 in the SER, which is the SER coordinated processing component 48-3 (not shown). The SER coordinated processing component 48-2 then outputs the feedback signal S_{FB}³¹.

The first iteration of the SER continues in this manner until the SER coordinated processing component 48-M receives a feedback signal S_{FB}^{M1} from its preceding SER coordinated processing component 48-(M−1) in the SER. Upon receiving the feedback signal S_{FB}^{M1}, the SER coordinated processing component 48-M computes an estimate of the impulse response H_{M} of the transmit path 60-M for the first iteration, which is referred to as the estimate H_{M1} of the impulse response H_{M} of the transmit path 60-M, based on the feedback signal S_{FB}^{M1} and the input signal S_{M}. The SER coordinated processing component 48-M then removes a contribution (i.e., S_{M}*H_{M1}) of the transmit path 60-M from the feedback signal S_{FB}^{M1} to thereby provide a feedback signal Sa for the next SER coordinated processing component 48 in the SER, which is the SER coordinated processing component 48-1 (i.e., the feedback signal S_{FB}¹² is the feedback signal for the SER coordinated processing component 48-1 for a second iteration of the SER). The SER coordinated processing component 48-M then outputs the feedback signal S_{FB}¹² to the SER coordinated processing component 48-1 for the second iteration of the SER.

Next, a second iteration of the SER is performed. In the second iteration of the SER, the SER coordinated processing component 48-1 first adds the contribution (i.e., S₁*H₁₁) of the transmit path 60-1 removed in the previous iteration of the SER back into the feedback signal S_{FB}¹² to thereby provide a modified feedback signal S_{FB}¹²′. The SER coordinated processing component 48-1 then computes a new estimate of the impulse response H₁ of the transmit path 60-1 for the second iteration, which is referred to as the estimate H₁₂ of the impulse response H₁ of the transmit path 60-1, based on the modified feedback signal S_{FB}¹²′ and the input signal S₁. The SER coordinated processing component 48-1 then removes a contribution (i.e., S₁*H₁₂) of the transmit path 60-1 from the modified feedback signal S_{FB}¹²′ to thereby provide a feedback signal S_{FB}²² for the next SER coordinated processing component 48 in the SER, which is the SER coordinated processing component 48-2. The SER coordinated processing component 48-1 then outputs the feedback signal S_{FB}²² for the SER coordinated processing component 48-2.

Likewise, upon receiving the feedback signal S_{FB}²², the SER coordinated processing component 48-2 adds the contribution (i.e., S₂*H₂₁) of the transmit path 60-2 removed in the previous iteration of the SER back into the feedback signal S_{FB}²² to thereby provide a modified feedback signal S_{FB}²²′. The SER coordinated processing component 48-2 then computes a new estimate of the impulse response H₂ of the transmit path 60-2 for the second iteration, which is referred to as the estimate H₂₂ of the impulse response H₂ of the transmit path 60-2, based on the modified feedback signal S_{FB}²²′ and the input signal S₂. The SER coordinated processing component 48-2 then removes a contribution (i.e., S₂*H₂₂) of the transmit path 60-2 from the modified feedback signal S_{FB}²²′ to thereby provide a feedback signal S_{FB}³² for the next SER coordinated processing component 48 in the SER, which is the SER coordinated processing component 48-3. The SER coordinated processing component 48-2 then outputs the feedback signal S_{FB}³² for the SER coordinated processing component 48-3.

The second iteration of the SER continues in this manner until the final SER coordinated processing component 48-M receives a feedback signal S_{FB}^{M2} from its preceding SER coordinated processing component 48-(M−1) in the SER. Upon receiving the feedback signal S_{FB}^{M2}, the SER coordinated processing component 48-M adds the contribution (i.e., S_{M}*H_{M1}) of the transmit path 60-M removed in the previous iteration of the SER back into the feedback signal S_{FB}^{M2} to thereby provide a modified feedback signal S_{FB}^{M2′}. The SER coordinated processing component 48-M then computes a new estimate of the impulse response H_{M} of the transmit path 60-M for the second iteration, which is referred to as the estimate H_{M2} of the impulse response H_{M} of the transmit path 60-M, based on the modified feedback signal S_{FB}^{M2}′ and the input signal S_{M}. The SER coordinated processing component 48-M then removes a contribution (i.e., S_{M}*H_{M2}) of the transmit path 60-M from the modified feedback signal S_{FB}^{M2}′ to thereby provide a feedback signal S_{FB}¹³ for the next SER coordinated processing component 48 in the SER, which is the SER coordinated processing component 48-1. The SER coordinated processing component 48-M then outputs the feedback signal S_{FB}¹³ for the SER coordinated processing component 48-1.

Iterations of the SER continue in this manner until a final iteration of the SER is reached. Note that the desired number of iterations is, in one embodiment, greater than or equal to 2. In another embodiment, the number of iterations is greater than or equal to 8. Note that the number of iterations performed is, in one embodiment, a tradeoff between accuracy and time.

In the final iteration, the SER coordinated processing component 48-1 receives a feedback signal S_{FB}^{1N} from the SER coordinated processing component 48-M, where N is the number of iterations performed by the SER. Upon receiving the feedback signal sit the SER coordinated processing component 48-1 adds the contribution (i.e., S₁H*_{1(N-1)}) of the transmit path 60-1 removed in the previous iteration (i.e., the (N−1)th iteration) of the SER back into the feedback signal S_{FB}^{1N} to thereby provide a modified feedback signal S_{FB}^{1N}′. The SER coordinated processing component 48-1 then computes a new estimate of the impulse response H₁ of the transmit path 60-1 for the Nth iteration, which is referred to as the estimate H_{1N} of the impulse response H₁ of the transmit path 60-1, based on the modified feedback signal S_{FB}^{1N}′ and the input signal S₁. The SER coordinated processing component 48-1 then removes a contribution (i.e., S₁*H_{1N}) of the transmit path 60-1 from the modified feedback signal S_{FB}^{1N}′ to thereby provide a feedback signal S_{FB}^{2N} for the next SER coordinated processing component 48 in the SER, which is the SER coordinated processing component 48-2. The SER coordinated processing component 48-1 then outputs the feedback signal S_{FB}^{2N} for the SER coordinated processing component 48-2.

Likewise, upon receiving the feedback signal S_{FB}^{2N}, the SER coordinated processing component 48-2 adds the contribution (i.e., S₂*H_{2(N-1)}) of the transmit path 60-2 removed in the previous iteration (i.e., the (N−1)th iteration) of the SER back into the feedback signal S_{FB}^{2N} to thereby provide a modified feedback signal S_{FB}^{2N}′. The SER coordinated processing component 48-2 then computes a new estimate of the impulse response H₂ of the transmit path 60-2 for the Nth iteration, which is referred to as the estimate H_{2N} of the impulse response H₂ of the transmit path 60-2, based on the modified feedback signal Sir and the input signal S₂. The SER coordinated processing component 48-2 then removes a contribution (i.e., S₂*H_{2N}) of the transmit path 60-2 from the modified feedback signal S_{FB}^{2N}′ to thereby provide a feedback signal S_{FB}^{3N} for the next SER coordinated processing component 48 in the SER, which is the SER coordinated processing component 48-3. The SER coordinated processing component 48-2 then outputs the feedback signal S_{FB}^{3N} for the SER coordinated processing component 48-3.

The Nth (or final) iteration of the SER continues in this manner until the final SER coordinated processing component 48-M receives a feedback signal S_{FB}^{MN} from its preceding SER coordinated processing component 48-(M−1) in the SER. Upon receiving the feedback signal S_{FB}^{MN}, the SER coordinated processing component 48-M adds the contribution (i.e., S_{M}*H_{M(N-1)}) of the transmit path 60-M removed in the previous iteration (i.e., the (N−1)th iteration) of the SER back into the feedback signal S_{FB}^{MN} to thereby provide a modified feedback signal S_{FB}^{MN}′. The SER coordinated processing component 48-M then computes a new estimate of the impulse response H_{M} of the transmit path 60-M for the Nth iteration, which is referred to as the estimate H_{MN} of the impulse response H_{M} of the transmit path 60-M, based on the modified feedback signal S_{FB}^{MN}′ and the input signal S_{M}.

At this point, the process is complete. The estimates H_{1N} through H_{MN} are the final estimates of the impulse responses H₁ through H_{M} of the transmit paths 60-1 through 60-M. The final estimates of the impulse responses H₁ through H_{M} of the transmit paths 60-1 through 60-M are then used by the equalizer synthesis components 50-1 through 50-M to configure the equalizers 44-1 through 44-M to correct or compensate for linear distortions (i.e., to equalize) of the transmit paths 60-1 through 60-M. Notably, during operation, the estimation process performed by the SER may be repeated as desired in order to update the final estimates of the impulse responses H₁ through H_{M} of the transmit paths 60-1 through 60-M over time in order to account for changes in the impulse responses H₁ through H_{M} of the transmit paths 60-1 through 60-M.

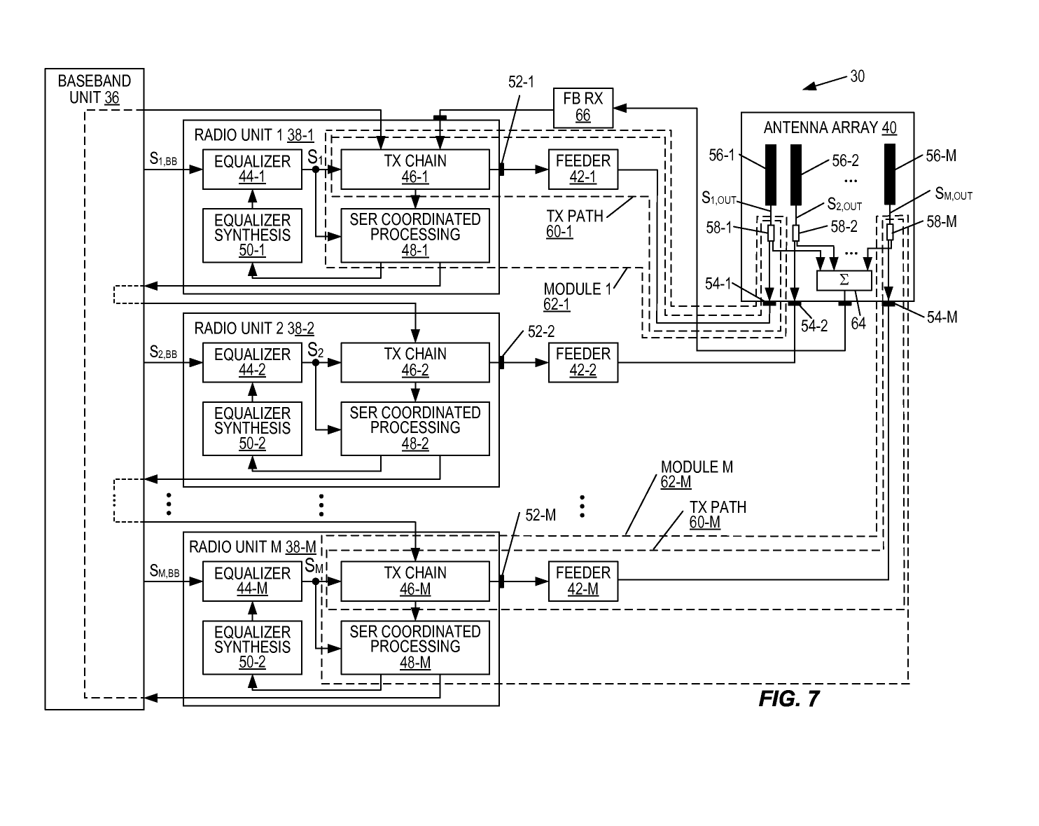

FIG. 7 illustrates the base station 30 according to another embodiment of the present disclosure. This embodiment is similar to that of FIG. 6 but where the base station 30 includes multiple radio units 38-1 through 38-M. The transmit chains 46-1 through 46-M together with the SER coordinated processing components 48-1 through 48-M are implemented in different radio units 38. Thus, the transmit chain 46-1 and the SER coordinated processing component 48-1 are implemented in the radio unit 38-1, the transmit chain 46-2 and the SER coordinated processing component 48-2 are implemented in the radio unit 38-2, etc. Note that while all of the transmit chains 46-1 through 46-M and their corresponding SER coordinated processing components 48-1 through 48-M are implemented in different radio units 38 in this embodiment, in an alternative embodiment, some of the transmit chains 46-1 through 46-M and their corresponding SER coordinated processing components 46-1 through 46-M may be implemented in the same radio unit 38. For example, the transmit chains 46-1 and 46-2 and the corresponding SER coordinated processing components 48-1 and 48-2 may all be implemented in a single radio unit 38, where the rest of the transmit chains 46-3 through 46-M and the corresponding SER coordinated processing components 48-3 through 48-M may be implemented in different radio units 38.

In this embodiment, the feedback receiver 66 is shown as being implemented external to the radio units 38-1 through 38-M. However, in another embodiment, the feedback receiver 66 may be implemented in one or all of the radio units 38-1 through 38-M (e.g., each of the radio units 38-1 through 38-M may include a feedback receiver such that a SER coordinated processing component 48 of any one of the radio units 38-1 through 38-M can be utilized as the first SER coordinated processing component in the SER). Also, the feedback signals S_{FB}^{mi} are sent between the SER coordinated processing components 48-1 through 48-M via the baseband unit 36 in this embodiment. However, the feedback signals S_{FB}^{mi} may alternatively be communicated directly between the different radio units 38-1 through 38-M.

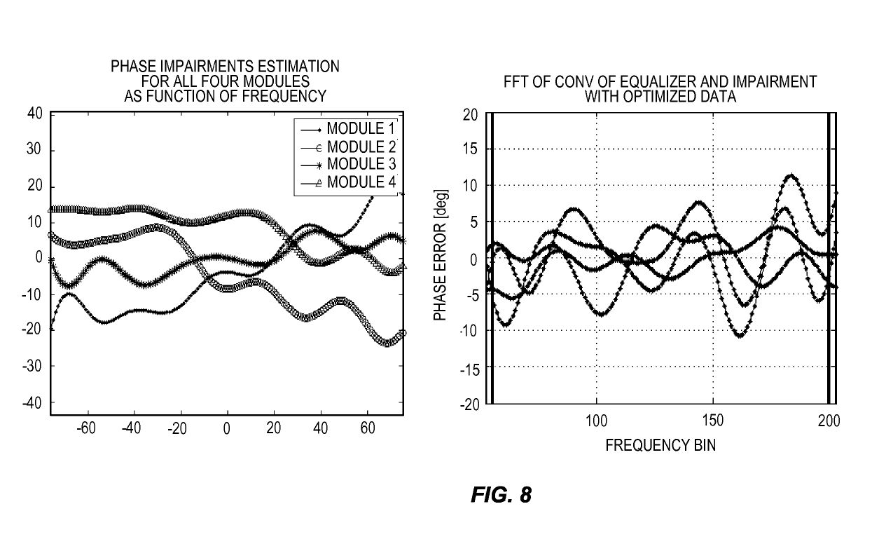

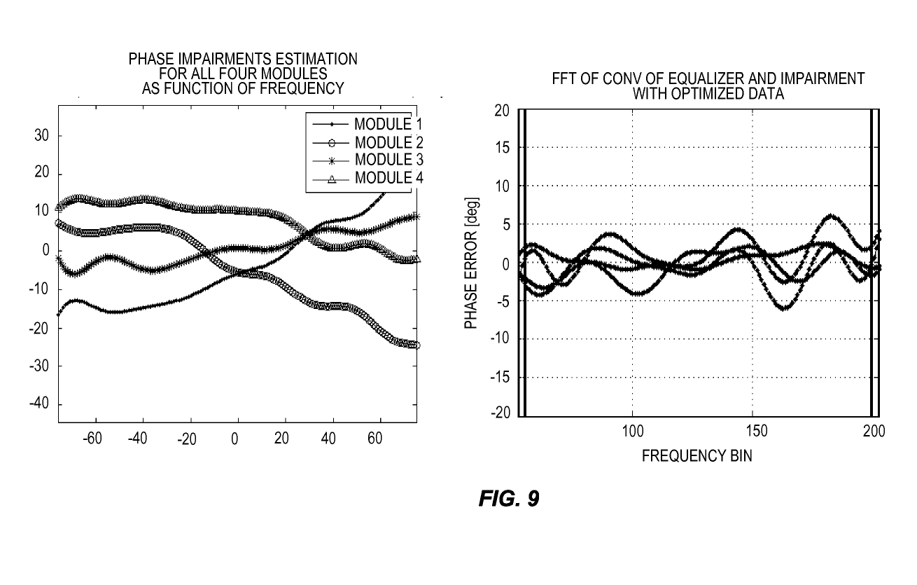

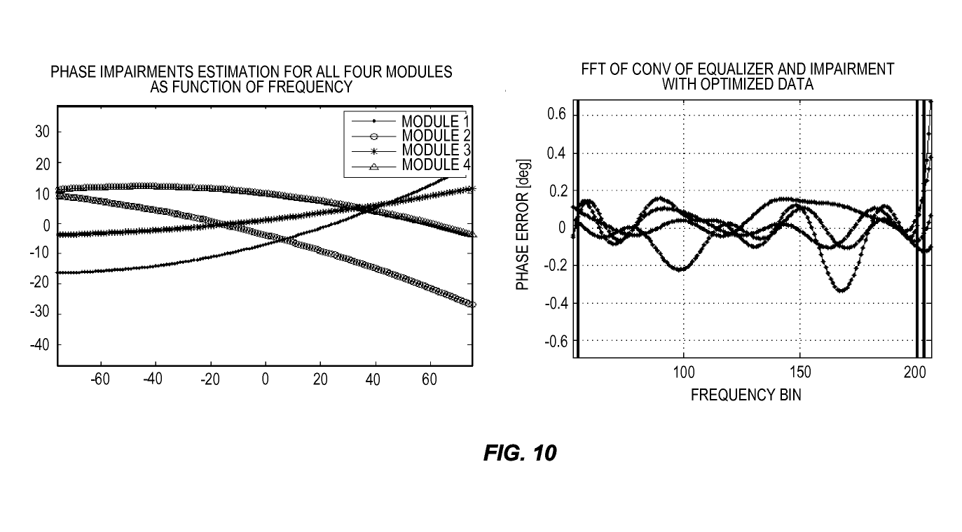

FIGS. 8 through 10 illustrate simulation results for one example implementation of the SER of FIGS. 6 and 7 where M=4 and N=8. In particular, FIGS. 8 through 10 illustrate the impairment estimation and phase accuracy over frequency after the first iteration of the SER, after the second iteration of the SER, and after the eighth iteration of the SER, respectively. From FIG. 8, it can be seen that the phase accuracy is relatively poor at ±12 degrees after the first iteration. However, as can be seen from FIG. 10, the phase accuracy improves to a nearly ideal ±0.3 degrees after only eight iterations of the SER.

The SER coordinated processing components 24 and 48 described above can be implemented in any suitable manner. In one embodiment, each SER coordinated processing component 24, 48 is implemented in hardware or a combination of hardware and software (e.g., at least one processor executing software that instructs the processor to provide the functionality of the SER coordinated processing component 24, 48 according to any of the embodiments described herein). In another embodiment, a computer program is provided that includes instructions which, when executed on at least one processor, cause the at least one processor to carry out any of the methods of operation of a SER coordinated processing component 24, 48 discussed above. In another embodiment, a carrier containing the aforementioned computer program is provided, where the carrier is one of an electronic signal, an optical signal, a radio signal, or a computer readable storage medium (e.g., a non-transitory computer readable medium).

While not being limited by any particularly advantage(s), some embodiments of the SER disclosed herein allow for a simplified configuration for coordinated impulse response estimation processing in modular and scalable systems. In addition, some embodiments allow for processing to be distributed across modules and, therefore, lead to less processing per module compared to a centralized architecture. Still further, the number of interconnects between modules is reduced as compared to a centralized architecture. Due to the ring topology, the SER allows unlimited scalability with reduced cost and complexity.

The following acronyms are used throughout this disclosure.
4G 4^{th} Generation
5G 5^{th} Generation
SER Scalable Estimation Ring

Those skilled in the art will recognize improvements and modifications to the embodiments of the present disclosure. All such improvements and modifications are considered within the scope of the concepts disclosed herein and the claims that follow.

What is claimed is:

1. A method of operation of a scalable estimation ring coordinated processing component in a scalable estimation ring comprising a plurality of scalable estimation ring coordinated processing components that operate to estimate impulse responses of a corresponding plurality of channels, comprising:
receiving a feedback signal for the scalable estimation ring coordinated processing component;
computing an initial estimate of an impulse response of a corresponding channel based on the feedback signal for the scalable estimation ring coordinated processing component;
removing a contribution of the corresponding channel from the feedback signal for the scalable estimation ring coordinated processing component based on the initial estimate of the impulse response of the corresponding channel to thereby provide a feedback signal for a next scalable estimation ring coordinated processing component in the scalable estimation ring; and
outputting the feedback signal for the next scalable estimation ring coordinated processing component in the scalable estimation ring.

2. The method of claim 1 further comprising:
receiving a new feedback signal output by a preceding scalable estimation ring coordinated processing component in the scalable estimation ring;
adding the contribution of the corresponding channel previously removed from the feedback signal for the scalable estimation ring coordinated processing component based on the initial estimate of the impulse response of the corresponding channel into the new feedback signal to thereby provide a modified new feedback signal;
computing a new estimate of the impulse response of the corresponding channel based on the modified new feedback signal;
removing a contribution of the corresponding channel from the modified new feedback signal based on the new estimate of the impulse response of the corresponding channel to thereby provide a new feedback signal for the next scalable estimation ring coordinated processing component in the scalable estimation ring; and
outputting the new feedback signal for the next scalable estimation ring coordinated processing component in the scalable estimation ring.

3. The method of claim 2 wherein the scalable estimation ring coordinated processing component is a first scalable estimation ring coordinated processing component in the scalable estimation ring, and receiving the feedback signal for the scalable estimation ring coordinated processing component comprises receiving a combined feedback signal, the combined feedback signal being a summation of a plurality of output signals of the plurality of channels in response to a plurality of input signals.

4. The method of claim 2 wherein the plurality of channels is a plurality of transmit paths of a base station of a cellular communications network, the base station having an antenna array comprising a plurality of antenna sub-arrays, further wherein each transmit path of the plurality of transmit paths is connected to a corresponding one of the plurality of antenna sub-arrays.

5. The method of claim 4 wherein each transmit path of the plurality of transmit paths comprises a transmit chain, a feeder having a first end connected to an output of the transmit chain and a second end, and a coupler configured to connect the second end of the feeder to a corresponding one of the plurality of sub-arrays, and the transmit paths of the plurality of transmit paths are implemented in a single radio unit.

6. The method of claim 4 wherein each transmit path of the plurality of transmit paths comprises a transmit chain, a feeder having a first end connected to an output of the transmit chain and a second end, and a coupler configured to connect the second end of the feeder to a corresponding one of the plurality of sub-arrays, and the transmit chains of at least two of the plurality of transmit paths are implemented in different radio units.

7. The method of claim 4 wherein each transmit path of the plurality of transmit paths comprises a transmit chain, a feeder having a first end connected to an output of the transmit chain and a second end, and a coupler configured to connect the second end of the feeder to a corresponding one of the plurality of sub-arrays, and the transmit chains of the plurality of transmit paths are implemented in different radio units.

8. The method of claim 2 wherein the plurality of channels is a plurality of receive paths of a base station of a cellular communications network, the base station having an antenna array comprising a plurality of antenna sub-arrays, further wherein each receive path of the plurality of receive paths is connected to a corresponding one of the plurality of antenna sub-arrays.

9. The method of claim 2 wherein, for each scalable estimation ring coordinated processing component of the plurality of scalable estimation ring coordinated processing components in the scalable estimation ring, removing the contribution of the corresponding channel from the feedback signal for the next scalable estimation ring coordinated processing component based on the initial estimate comprises subtracting a convolution of a corresponding input signal of a plurality of input signals of the plurality of channels and the initial estimate of the impulse response of the corresponding channel from the feedback signal for the next scalable estimation ring coordinated processing component.

10. The method of claim 9 wherein, for each scalable estimation ring coordinated processing component of the plurality of scalable estimation ring coordinated processing components in the scalable estimation ring:
adding the contribution of the corresponding channel previously removed from the combined feedback signal based on the initial estimate into the new feedback signal comprises adding the convolution of the corresponding input signal of the plurality of input signals and the initial estimate of the impulse response of the corresponding channel to the new feedback signal to thereby provide the modified new feedback signal; and
removing the contribution of the corresponding channel from the modified new feedback signal based on the new estimate for the scalable estimation ring coordinated processing component comprises subtracting a convolution of the corresponding input signal of the plurality of input signals and the new estimate of the impulse response of the corresponding channel from the modified new feedback signal.

11. The method of claim 1 wherein outputting the feedback signal comprises outputting the feedback signal to a baseband unit for distribution to the next scalable estimation ring coordinated processing component in the scalable estimation ring.

12. The method of claim 1 wherein outputting the feedback signal comprises outputting the feedback signal directly to the next scalable estimation ring coordinated processing component in the scalable estimation ring.

13. A method of operation of a scalable estimation ring comprising a plurality of scalable estimation ring coordinated processing components to estimate impulse responses of a corresponding plurality of channels, comprising:
performing an initial iteration of the scalable estimation ring, wherein performing the initial iteration comprises:
for each scalable estimation ring coordinated processing component of the plurality of scalable estimation ring coordinated processing components in the scalable estimation ring:
receiving a feedback signal for the scalable estimation ring coordinated processing component;
computing an initial estimate of an impulse response of a corresponding channel based on the feedback signal for the scalable estimation ring coordinated processing component;
removing a contribution of the corresponding channel from the feedback signal for the scalable estimation ring coordinated processing component based on the initial estimate of the impulse response of the corresponding channel to thereby provide a feedback signal for a next scalable estimation ring coordinated processing component in the scalable estimation ring; and
outputting the feedback signal for the next scalable estimation ring coordinated processing component in the scalable estimation ring.

14. The method of claim 13 wherein:
for a first scalable estimation ring coordinated processing component in the scalable estimation ring, receiving the feedback signal for the initial iteration comprises receiving a combined feedback signal that is a summation of a plurality of output signals of the plurality of channels in response to a plurality of input signals; and
for each additional scalable estimation ring coordinated processing component in the scalable estimation ring, receiving the feedback signal for the initial iteration comprises receiving the feedback signal output by a preceding scalable estimation ring coordinated processing component in the scalable estimation ring for the initial iteration.

15. The method of claim 14 further comprising performing a second iteration of the scalable estimation ring, wherein performing the second iteration comprises, for each scalable estimation ring coordinated processing component of the plurality of scalable estimation ring coordinated processing components:
receiving a new feedback signal output by a preceding scalable estimation ring coordinated processing component in the scalable estimation ring;
adding the contribution of the corresponding channel removed in the initial iteration of the scalable estimation ring into the new feedback signal to thereby provide a modified new feedback signal;
computing a new estimate of the impulse response of the corresponding channel based on the modified new feedback signal;
removing a contribution of the corresponding channel from the modified new feedback signal based on the new estimate of the impulse response of the corresponding channel to thereby provide a new feedback signal for the next scalable estimation ring coordinated processing component in the scalable estimation ring; and
outputting the new feedback signal for the next scalable estimation ring coordinated processing component in the scalable estimation ring.

16. The method of claim 15 wherein the plurality of channels is a plurality of transmit paths of a base station of a cellular communications network, the base station having an antenna array comprising a plurality of antenna sub-arrays, further wherein each transmit path of the plurality of transmit paths is connected to a corresponding one of the plurality of antenna sub-arrays.

17. The method of claim 16 wherein each transmit path of the plurality of transmit paths comprises a transmit chain, a feeder having a first end connected to an output of the transmit chain and a second end, and a coupler configured to connect the second end of the feeder to a corresponding one of the plurality of sub-arrays.

18. The method of claim 16 wherein the transmit chains of the plurality of transmit paths are implemented in a single radio unit.

19. The method of claim 16 wherein the transmit chains of at least two of the plurality of transmit paths are implemented in different radio units.

20. The method of claim 16 wherein the transmit chains of the plurality of transmit paths are implemented in different radio units.

21. The method of claim 15 wherein, for each scalable estimation ring coordinated processing component of the plurality of scalable estimation ring coordinated processing components in the scalable estimation ring, when performing the initial iteration, removing the contribution of the corresponding channel from the feedback signal for the scalable estimation ring coordinated processing component comprises subtracting a convolution of a corresponding input signal of the plurality of input signals and the initial estimate of the impulse response of the corresponding channel from the feedback signal for the scalable estimation ring coordinated processing component.

22. The method of claim 21 wherein, for each scalable estimation ring coordinated processing component of the plurality of scalable estimation ring coordinated processing components in the scalable estimation ring, when performing the second iteration:
adding the contribution of the corresponding channel removed in the initial iteration of the scalable estimation ring into the new feedback signal comprises adding the convolution of the corresponding input signal of the plurality of input signals and the initial estimate of the impulse response of the corresponding channel computed in the initial iteration to the new feedback signal to thereby provide the modified new feedback signal; and
removing the contribution of the corresponding channel from the modified new feedback signal for the scalable estimation ring coordinated processing component comprises subtracting a convolution of the corresponding input signal of the plurality of input signals and the new estimate of the impulse response of the corresponding channel from the modified new feedback signal for the scalable estimation ring coordinated processing component.

23. A base station for a wireless network that performs calibration of an antenna array to remove distortion incurred by a plurality of transmit paths in the base station, the antenna array including a plurality of sub-arrays each connected to a corresponding one of the plurality of transmit paths, the base station comprising:
a feedback receiver configured to receive a combined radio frequency feedback signal and output a combined feedback signal, the combined radio frequency feedback signal being a summation of a plurality of output signals of the plurality of transmit paths in response to a plurality of input signals; and
a scalable estimation ring configured to estimate impulse responses of the plurality of transmit paths based on the combined feedback signal in a distributed manner, the scalable estimation ring comprising a plurality of scalable estimation ring coordinated processing components each operating to estimate the impulse response of a corresponding one of the plurality of transmit paths.

24. The base station of claim 23 wherein each transmit path of the plurality of transmit paths comprises a transmit chain, a feeder having a first end connected to an output of the transmit chain and a second end, and a coupler configured to connect the second end of the feeder to a corresponding one of the plurality of sub-arrays.

25. The base station of claim 24 wherein the transmit chains of the plurality of transmit paths are implemented in a single radio unit.

26. The base station of claim 24 wherein the transmit chains of the plurality of transmit paths are implemented in different radio units.

27. The base station of claim 24 wherein the transmit chains of at least two of the plurality of transmit paths are implemented in different radio units.

28. The base station of claim 23 wherein, in order to estimate the impulse responses of the plurality of transmit paths, for an initial iteration of the scalable estimation ring, each scalable estimation ring coordinated processing component of the plurality of scalable estimation ring coordinated processing components in the scalable estimation ring is configured to:
receive a feedback signal for the scalable estimation ring coordinated processing component;
compute an initial estimate of the impulse response of a corresponding transmit path of the plurality of transmit paths based on the feedback signal for the scalable estimation ring coordinated processing component;
remove a contribution of the corresponding transmit path from the feedback signal for the scalable estimation ring coordinated processing component based on the initial estimate of the impulse response of the corresponding transmit path to thereby provide a feedback signal for a next scalable estimation ring coordinated processing component in the scalable estimation ring; and
output the feedback signal for the next scalable estimation ring coordinated processing component in the scalable estimation ring.

29. The base station of claim 28 wherein:
for a first scalable estimation ring coordinated processing component in the scalable estimation ring, the feedback signal for the initial iteration is the combined feedback signal from the feedback receiver; and
for each additional scalable estimation ring coordinated processing component in the scalable estimation ring, the feedback signal for the initial iteration is the feedback signal output by a preceding scalable estimation ring coordinated processing component in the scalable estimation ring for the initial iteration.

30. The base station of claim 29 wherein, in order to estimate the impulse responses of the plurality of transmit paths, for a second iteration of the scalable estimation ring, each scalable estimation ring coordinated processing component of the plurality of scalable estimation ring coordinated processing components in the scalable estimation ring is configured to:
receive a new feedback signal output by a preceding scalable estimation ring coordinated processing component in the scalable estimation ring;
add the contribution of the corresponding transmit path removed in the initial iteration of the scalable estimation ring into the new feedback signal to thereby provide a modified new feedback signal;
compute a new estimate of the impulse response of the corresponding transmit path based on the modified new feedback signal;
remove a contribution of the corresponding transmit path from the modified new feedback signal based on the new estimate of the impulse response of the corresponding transmit path to thereby provide a new feedback signal for the next scalable estimation ring coordinated processing component in the scalable estimation ring; and
output the new feedback signal for the next scalable estimation ring coordinated processing component in the scalable estimation ring.
